(19) United States
(12) Patent Application Publication
(10) Pub. No.: US 2012/0298139 A1
(43) Pub. Date: Nov. 29, 2012

(54) CLEANING METHOD FOR COATING SYSTEMS

(75) Inventor: Peter Naff, Schaan (LI)

(73) Assignee: OERLIKON TRADING AG, TRUBBACH, Trubbach (CH)

(21) Appl. No.: 13/574,817

(22) PCT Filed: Dec. 22, 2010
(86) PCT No.: PCT/EP10/07971

§ 371 Date: Jul. 24, 2012

(30) Foreign Application Priority Data
Jan. 25, 2010 (DE) 10 2010 005 762.2

(51) Int. Cl. B08B 5/02; B08B 7/00

(52) U.S. Cl. 134/7; 134/37

(57) ABSTRACT

The invention relates to a cleaning method to be used on secondary surfaces in coating systems. Before the coating, an anti-adhesion layer (10) is applied to the secondary surfaces. After coating material has been deposited onto the anti-adhesion layer, the secondary surfaces are cleaned by means of dry ice blasting or CO₂ snow-jet cleaning.

### Technical field the Invention to Which the Invention Pertains

The invention relates to a cleaning method in connection with coating systems, in particular in connection with vacuum coating systems. During the coating process, it is generally unavoidable for surfaces to be coated in the coating chamber for which coating is not desired. Such surfaces can for example be parts of the chamber as well as parts of the substrates to be coated as well as holding surfaces or other secondary surfaces. After one or several coatings, these must generally be painstakingly cleaned. This is in particular necessary when the coating on the surfaces for which coating is not desired affects their surface characteristics, such as for example their electric conductivity. Thanks to the inventive method, this cleaning is made considerably simpler. In the frame of this invention disclosure, the unintentionally coated surfaces are called secondary surfaces whilst the deliberately coated surfaces are referred to as target surfaces. The secondary surfaces are connected to different potentials, such as bias current, insulating resp. to ground. This causes different adhesive strengths of the coating to arise on secondary surfaces.

### State of the Art to Date

It is known in the state of the art how to remove such undesirable coatings by means of different methods, such as for example sandblasting, grinding, scrubbing or even mechanical post-processing or chemical stripping processes. All these methods are common practice and widely used in the industry. Because of the usually great adhesive strength of these unwanted coatings on the secondary surfaces, their removal is almost consistently very time-consuming. Firstly, in some cases, the secondary surfaces need to be cleaned after each coating process (batch). Some cleaning methods, For example wet-chemical stripping or sandblasting, require.

Additionally, all abrasive cleaning methods (sandblasting, grinding etc.) entail considerable additional material wear for the processed components. This causes additional high maintenance costs (replacement of the worn components).

Furthermore, this material wear causes reduced process reliability, since in some circumstances mechanical tolerances relevant for the coating process can no longer be complied with.

Methods are known for removing impurities or coatings on surfaces by means of dry ice blasting. In this respect, solid CO2 ice crystals are used as blasting medium. By expansion of the liquid CO2 at the nozzle exit, CO2 snow is produced; it is accelerated to ultrasonic speed with the aid of a compressed-air jacketed jet and blasted onto the surface to be cleaned. According to WO02/072313, it is also possible to remove coatings. However, problems arise if the layer thickness is less than 2 μm, as the thereto-mechanic effects of the dry ice blast cannot be fully realized at such thicknesses. For the cleaning of elements of PVD (physical vapor deposition) or CVD (chemical vapor deposition) coating facilities, these methods could accordingly not be used so far.

WO08/040819 describes an improvement of the above mentioned dry ice blasting cleaning method insofar as a functional layer is provided on the surface to be cleaned, to which the contamination adheres less than it would to the surface to be cleaned. A plasma polymer layer is proposed as functional layer. In this connection, generally both organic as well as non-organic materials to be removed are considered contaminations. The functional layer has a lower thermal conductivity there than the object to be cleaned and the contamination adheres less fast to the functional layer than it would to the surface of the object lying under the functional layer. However, under these conditions several drawbacks are inherent in relation to PVD or CVD coating facilities:
During the coating process, i.e. when the vacuum chamber is being operated, the contamination should very well adhere to the surface, otherwise spelling could result in the substrates to be coated becoming themselves contaminated in an undesirable manner.
Due to the vacuum, the vacuum chambers will have very low temperatures that can suddenly increase sharply at the beginning of the coating process. A coating with a lower thermal conductivity can itself suffer damages at such temperatures.
The plasma polymer layer is itself applied in the context of a CVD process. Similarities the layer properties between the functional layer and the contamination are thus to be expected in some cases.
The plasma polymer layer is non conductive. The components of the coating chamber should however as a general rule have a conductive surface in order not to influence negatively the electric and/or magnetic conditions for the coating process,

### Technical tasks of the present invention

It would therefore be desirable for a method to be made available that would overcome the disadvantages of the state of the art at least partly. It would concretely be desirable to have a simplified cleaning method for secondary surfaces that can additionally be performed with considerably less time expenditure and that does not cause material wear of the components that are to be cleaned.

### Indication of the general solution rasp. of the approach

The basic idea of the present invention is to subject, even prior to the coating process, the secondary surfaces to a pre-treatment such that during the subsequent coating process, the adhesiveness of the coating material on the secondary surfaces is considerably reduced by comparison with adhesiveness without pre-treatment. In this manner, the cleaning process is made considerably easier.

Such an inventive pre-treatment can for example consist in applying a suitable “anti-adhesive layer” onto the secondary surfaces. The anti-adhesive layer is characterized by a low adhesiveness on the secondary surfaces or by a low adhesiveness of the contamination on the anti-adhesive layer. As the “anti-adhesive layer” after the coating itself ends up being between the secondary surface and the material deposited during the coating process, the adhesiveness of the coating material is effectively inhibited. Depending on the kind of coating process, the anti-adhesive layer needs to be temperature-resistant, electrically conductive and neutral from the point of view of vacuum technology. In particular neutrality for vacuum technology constitutes a prerequisite for PVD processes. The application of the anti-adhesive coating should preferably not have any negative influence of the properties of the layer itself on the target surfaces.

For the cleaning process it is then possible to use the dry ice blasting method, as described above. The cleaning method itself is known to the one skilled in the art sufficiently for example from WO08/040819 or WO02/07312 and does not need to be described here any further.

### DETAILED DESCRIPTION OF THE INVENTION

The invention will now be explained in detail on the basis of examples and with the aid of the figures.

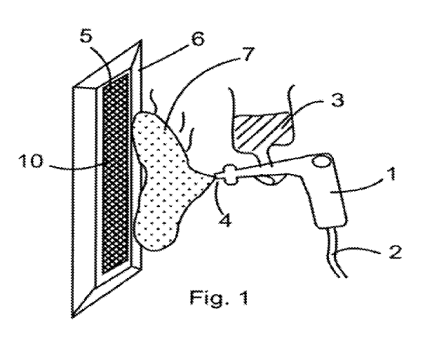

FIG. 1 sketches the process of the inventive pre-treatment.

FIG. 2 sketches an example for the use of a masking screen.

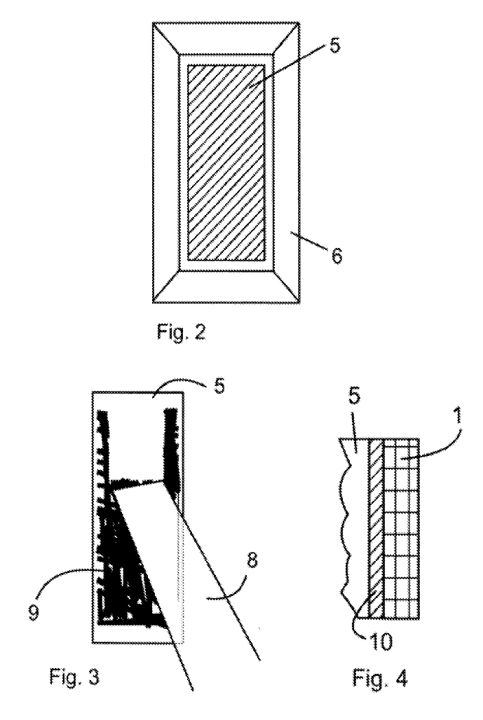

FIG. 3 sketches the facilitated cleaning process after the coating process.

FIG. 4 sketches the cross section through a surface provided with an anti-adhesive layer and a coating.

The following description is limited to a PVD process, though the frame of the invention is not to be limited to such a process.

For such a PVD process, it is important that the anti-adhesive layer should be suitable for vacuum. This however means that the anti-adhesive layer cannot contain any bonding agents or similar additives.

The inventors have discovered that this can be achieved according to a first embodiment of the present invention if a powder suspension in a slightly volatile solvent in a suitable mixing ratio is used when applying the anti-adhesive layer on the secondary surfaces. The slightly volatile solvent cannot enter into a chemical bond with the used powder or the treated surface. By using a volatile solvent as carder medium for the suspension, it can be ensured that the solvent has already completely evaporated immediately after the spraying process and only a weakly adhesive powder layer remains on the surface. As a solvent, isopropanol for example is very well suited.

The inventors have further discovered that pure graphite is suitable as powder material. Graphite powder especially under vacuum is sufficiently temperature-resistant, electrically conductive and suitable for vacuum processes, and it fulfills anti-adhesive properties and can thus be used in the PVD process.

The aim is achieved for example by spraying using a spray gun. This can be done without additional gas or with gas support. In the latter case, atmospheric nitrogen but also CO2 are suitable among others. The influencing factors that are relevant for the spraying process (e.g. injection pressure, pistol nozzle size, suspension mixing ratio, spraying distance and duration) can be adjusted in many ways in order to provide a homogenous layer application of adequate thickness for a plurality of applications. Depending on the application, other application methods (brushing, dipping, etc.) are also possible.

The anti-adhesive layer ensures that during the PVD process, coating material that is deposited on the treated secondary surfaces can essentially be removed entirely as described above by using the dry ice blasting method. This can occur by means of pellet jets or by means of CO₂ snow. A further possibility consists in using the dry ice and water mixed-jet method, as is described in DE102006002653. A further post-treatment is not necessary, the secondary surfaces can immediately be provided again with a new anti-adhesive layer for the next use.

Thanks to the outstanding good effectiveness and simplicity of use, many different applications, for example in the context of the PVD process, are conceivable.

In connection with arc evaporation, so-called confinement rings are often used. These surround the evaporation source's target having the coating material and ensure that the arc remains limited to the area of the target surface. Because of its proximity to the target material, they are subjected to a strong material application during the PVD coating process and their cleaning so far has required extremely aggressive methods such as for example sandblasting or even post-processing by machining. With the inventive application of the graphite powder, the necessary electric conductivity is retained. The coating material deposited during the PVD process ends up on the graphite layer. The graphite layer, including the coating, is then easily removed from the confinement ring.

The same applies for substrate holders that hold, during the coating process, the substrates to be coated. Because of their spatial proximity to the substrates to be coated, they are also heavily coated. After coating, the substrate holders have so far needed to be treated in time-consuming and therefore cost-intensive manner. Sandblasting causes high wear. In addition to the reduced process reliability, the expensive holders therefore needed to be replaced frequently. If the substrate holders are pre-treated with an anti-adhesive layer according to the invention, they can be cleaned after the PVD process easily, quickly and without wear.

The same goes for the carousel and the evaporation protection plate of a PVD facility. If the system further includes anodes to provide a plasma discharge, for example sputter sources, low voltage arc discharges and etching equipment, these can advantageously also be pre-treated prior to a coating step by application of an anti-adhesive layer.

According to a further embodiment of the present invention, the anti-adhesive itself is applied in a coating system as a relatively loose layer. To this effect, the substrate carriers are placed in the coating system without fittings. Such a layer can be for example a PVD layer that is coated without bias voltage. Such a layer can in turn be a graphite layer.

According to a further embodiment of the present invention, a copper arc coating is proposed as an anti-adhesive layer. In contrast to a plasma polymer layer, copper has excellent electrical conductivity and exhibits a greater thermal conductivity than for example the inorganic non-metallic layers applied by means of PVD. Formulated in more general terms, as anti-adhesive layer it is possible to use metallic, i.e. good thereto-conductive layers that are very different as regards thermal material properties from the PVD layer properties. The layer thickness of the copper arc coating preferably lies in the range from 0.1-0.4 mm, whilst the layer thickness of the contamination lies in the range from 1-100 μm.

According to a further embodiment, it is proposed to provide the surface with a so-called nano-sealing. It is known with this effect, known as so-called lotus effect, that contaminations adhere less well onto the structured surface and are thus easier to remove. By selecting the structure size accordingly, it is essentially possible to set the adhesive strength. In particular, tensions on the surface can be avoided by the structuring, so that spalling from the surface during the coating process is less to be feared.

As a concrete example of embodiment, the inventive method used for cleaning coated anode surfaces that are part of the etching device in the coating system will be described hereinafter in detail.

The problem represented here lies in the fact that for each PVD process, the anode surface is strongly coated with firmly adhering material. If further layers are added in subsequent coating processes, a very thick deposit that is extremely difficult (time-consuming) to remove will result in the course of time.

If layers that are poorly or not at all conductive are deposited, the poorly or not conductive deposits on the anode can cause the function of the anode to be impaired already after one coating process, so that for such processes the anode imperatively needs to be cleaned after each batch.

In order to perform this cleaning process, it is possible to proceed for example in the following manner:

The starting point is an anode, free from deposits and residues, i.e. the “virgin” anode even before the first coating process or after a cleaning treatment.

In a first step, the immediate vicinity of the anode with a surface that is to be coated with an anti-adhesive layer, representing in this case a secondary surface according to the definition given in this description, is covered and/or masked. A masking sheet with an adapted cutout and appropriate geometry can for example be an option. The masking sheet ensures that only the desired areas are provided with an anti-adhesive layer.

In a second step, the anti-adhesive layer is applied for example with a spraying method using a spray gun. In this case, a suspension containing the anti-adhesive layer material is sprayed onto the masked anode.

In order to prepare the suspension to be sprayed, graphite powder is mixed into isopropanol. In the described example, the anode is a vertically mounted metallic surface. It is therefore necessary to take care that the spraying distance and layer thickness are selected in such a way that excess solvent is prevented from running down onto the surface. It is thus very advantageous if the slightly volatile solvent in the aerosol can already evaporate to a large extent while on its way between the spray nozzle and the surface to be treated. This results in an optimum coating with graphite powder. In this context, the mixing ratio of solvent and graphite powder also plays a role. In order to prevent any running down, the proportion of graphite should be as high as possible. However, it is also necessary to take care that the nozzle of the spray gun does not become dogged. A ratio of 50 ml to 150 ml of isopropanol (IPA) for 10 g of graphite powder has proved suitable. Preferably, 100 ml IPA per 10 g of graphite powder is used.

The graphite powder used should be to a large extent without adjunction of bonding agents or other additives. In the present example, a purity of 99.9% was used. As regards the particle size of the graphite powder, 0.2 μm to 150 μm as maximum size have proved favorable. Advantageously, a graphite powder with particles not larger than 20 μm is used.

As spray gun, a commercially available gravity-fed spray gun was used. The nozzle size lies for example between 0.3 mm and 2 mm and is preferably 0.8 mm.

As medium for driving the spraying process, compressed air at a pressure between 0.2 bar and 1.0 bar, preferably between 0.5 bar and 0.7 bar, was used. The compressed air should be free of oil and as far as possible free of particles so that no impurity contaminates the suspension and thus the anti-adhesive layer. Particular care must be taken that the pistol's pneumatics does not introduce any impurities.

Prior to each use, the suspension is homogenized. This can occur by shaking, vibrating, by ultrasound treatment or other methods known to the one skilled in the art.

A spraying distance between 50 mm and 250 mm, ideally between 100 mm and 200 mm, is chosen. As already mentioned above, a great spraying distance is advantageous inasmuch as the solvent is given the opportunity to evaporate already during its flight time. A distance that is too great will however result in a wide spatial dispersion.

The layer thickness to be applied for the anti-adhesive layer is for example between 0.05 mm and 2.0 mm. In the present example, the criterion “optically-assessed extensive coverage” has proved suitable and, because of its simplicity, advantageous. At least if the secondary surfaces are themselves not graphite surfaces, it is easy to perform this on the basis of the optical characteristics of graphite powder. The application of the anti-adhesive layer takes place in the example in several and advantageously uniform spraying steps.

After application of the anti-adhesive layer, it is important to bear in mind that since the powder layer adheres to the surface essentially through adhesion forces, touching the coated secondary surfaces after the spraying should be avoided as much as possible. It is therefore advantageous, whenever possible, to treat the components in their final assembled state or accordingly to use suitable devices and/or tools (handling aids) so that any damage to the anti-adhesive layer can be avoided.

In a third step, the screen used for masking is removed. Attention is drawn again to the fact that such a masking is not required in every case, though it was used in this example.

The pre-treatment is thus completed and the PVD coating itself can be carried out in the usual manner, i.e. the coating chamber is loaded with work-pieces, the chamber is dosed and pumped out, the coating, e.g. arc evaporation, takes place and the coating chamber is then aired and opened. The inventive pre-treatment of the anode has in this respect no influence on the coating.

After opening the coating chamber, the secondary surfaces are cleaned according to the invention by means of dry ice blasting. The CO₂-snow deans in a manner that is gentle, dry, residue-free and suitable for vacuum processes.

Before the next coating process, the anode is again pre-treated according to the steps 1 to 3.

Ideally, this procedure is performed after each coating process. It is however also possible to forgo the cleaning by means of dry ice blasting after a coating step and to renew the anti-adhesive layer only after several coating cycles.

The invention has been described by way of example on the basis of a PVD coating system and of the pre-treatment of an ITE-anode placed in a vacuum chamber (ITE=Innova Etching Technology). In this example, the cleaning effort of 20 minutes so far could be reduced to a couple of minutes. Furthermore, the anode is protected from wear through the inventive method. The inventive pre-treatment can advantageously be used with other coating methods, in particular with other vacuum coating methods for example such as. If necessary, the material of the anti-adhesive layer could then be adapted.

Further examples of applications have already been mentioned. In particular, the invention can also be used advantageously for substrates to be coated in the case where for example only one part of the substrate surface is to be coated. So far, the surface parts of the substrates that were not to be coated had to be shielded by the holding fixtures. By means of thee inventive method, on the other hand, the parts of the substrate surface that are not to be coated are covered with an anti-adhesive layer that after coating can be cleaned in a simple manner by means of the dry-ice blasting method.

It is advantageous for often recurring similar anti-adhesive treatments (e.g. carousels, substrate holders, substrates etc.) to use an automatically operating spraying installation in a further development of the present invention.

Reference signs in the figures:

1 Gravity-fed spray gun

2 Compressed air net

3 Suspension

4 Spray nozzle

5 Secondary surface

6 Masking screen

7 Spray mist

8 Dry ice blast nozzle

9 Anti-adhesive layer covered with deposits

10 Anti-adhesive layer

11 Deposits from the PVD process

1. Cleaning method for secondary surfaces of coating facilities, comprising the following steps:
prior to the coating process, application of an anti-adhesive layer onto secondary surfaces of the coating chamber
after the coating process, treatment of the secondary surfaces by means of the dry ice blasting or CO₂ snow-jet cleaning method.

2. Method according to claim 1, characterized in that the anti-adhesive layer includes a suspension of powder in a volatile solvent.

3. Method according to claim 1, characterized in that the anti-adhesive layer includes a metallic layer that is considerably thicker than the layer applied during the coating process.

4. Method according to claim 1, characterized in that the anti-adhesive layer is a layer whose anti-adhesive effect is based on the lotus effect.
